(19) United States
(12) Patent Application Publication
(10) Pub. No.: US 2004/0128691 A1
(43) Pub. Date: Jul. 1, 2004

(54) Video browsing system, distribution server and browse client

(75) Inventors: Yutaka Egawa, Tokyo (JP); Eisuke Kanno, Tokyo (JP); Michitoshi Suzuki, Tokyo (JP); Shunsuke Nagatani, Tokyo (JP); Masakazu Ogawa, Tokyo (JP); Shinya Taguchi, Tokyo (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/658,266

(22) Filed: Sep. 10, 2003

(30) Foreign Application Priority Data
Dec. 25, 2002 (JP) 2002-373903

(51) Int. Cl. H04N 7/173; G09G 5/00; G06F 15/16; G06F 13/00; H04N 5/445; G06F 3/00

(52) U.S. Cl. 725/88; 725/53; 725/52; 709/217; 725/112; 725/113; 345/704; 725/102

(57) ABSTRACT

A browse client uses a viewing percentage counter to count the extent to which the user has played back and displayed content video data distributed from a distribution server on a screen, and transmits the extent information to the distribution server. The distribution server keeps track of the received browse extent information in a database in association with the content and the user and also sends the browse extent information to a management client having a setting unit for user registration and a mail unit of preparing electronic mail and transmitting electronic mail to each user for providing management information. The browse client provides the user with a playback button for making it possible to play back the video data starting at the previous stop point using the counted extent information.

### BACKGROUND OF THE INVENTION

1. Field of the Invention

This invention relates to a system for distributing video data (motion picture data) to users for browsing the video data and in particular to a system that can keep track of the extent to which the user browses video data.

2. Description of the Related Art

Service for distributing various types of content from a distribution server to browse clients such as personal computers and mobile terminals is widely conducted as specific-area or wide-area service.

Such content distribution systems are available in various modes; content data including video data is also distributed owing to the progression of network communication technologies.

An outline of a content browsing system is as follows: Various pieces of content data are registered in a distribution server and as a browse client accesses the distribution server and selects any desired content, the distribution server distributes the corresponding content data to the browse client and the user can view the content on the browse client.

The distributed video data is extended from that intended for entertainment such as movies to diversified video data of education, lectures and presentation.

As for video of education, lectures and presentation, conducted using written materials (documents), it is required to distribute a still image of the written material (slide data) as well as video image (video data) to each browse client for synchronously playing back the images to fill up the provided information, aid in learning the content, and deeply understand the content.

For example, in the video data intended for entertainment such as movies, the extent to which the browse user views each of the video titles distributed in a large number of types becomes important information to study video data of what contents should be distributed to meet the user needs in the future. In the video data intended for education and the like, the extent to which the browse user of a pupil views each of the video titles distributed in a large number of types becomes important information to keep track of the extent to which the browse user progresses on learning.

### SUMMARY OF THE INVENTION

It is therefore an object of the invention to keep track of the extent to which the user has browsed provided video data and the right of browsing of each user, and realize system administration adapted for the purpose in a system for providing content including video data for the user.

It is another object of the invention to make possible a progress management of learning of pupil users in using network technologies to realize an education field in which a lecturer gives a lecture to a user group, for example.

Other and further objects of the invention will be apparent from the following description.

The invention can be embodied in various forms such as a video browsing system, a distribution server and a management client making up the video browsing system, programs for implementing them as computers, and a video browse method.

In the invention, a distribution server for distributing content including video data has a function of keeping track of extent information of browsing the content for each user through a browse client for receiving the distributed content and playing back and displaying the video data on a screen. In one form of the invention, the browse client counts the extent to which the user has played back and displayed the distributed content video data on the screen and transmits the counted extent information to the distribution server.

Accordingly, for various pieces of video data distributed, the system can keep track of the interest, the learning progress, and the like, of each user based on the browse extent information (in an embodiment described below, viewing percentage).

In the invention, in the browse client, the screen may be provided with a playback button for playing back the video data starting at the previous stop point for the incompletely browsed content based on the counted extent information.

Accordingly, the playback button enables the user to know that the user has browsed the video data to a midpoint, and the user can operate the playback button to easily play back the beginning of the remaining portion of the video data.

In the invention, the system may further include a management client having a function of registering a user that can browse content in the distribution server and a function of preparing electronic mail and transmitting electronic mail to each user, wherein the distribution server may transmit the browse extent information to the management client for providing management information.

Accordingly, the manager operating the management client can keep track in organized manner of the browse users also including the browse extent information and moreover can reference the browse extent information and advertise video data and give guidance in video data learning by electronic mail for each user.

### BRIEF DESCRIPTION OF THE DRAWINGS

The above objects and advantages of the present invention will become more apparent by describing preferred exemplary embodiment thereof in detail with reference to the accompanying drawings, wherein:

FIG. 1 is a drawing to show a configuration of a system according to one embodiment of the invention;

FIG. 2 is a drawing to show data structures according to the embodiment of the invention;

FIG. 3 is a drawing to describe a relationship between video data and slide data according to the embodiment of the invention;

FIG. 4 is a drawing to show a screen display example of a browse client according to the embodiment of the invention;

FIG. 5 is a drawing to show a screen display example of the browse client according to the embodiment of the invention;

FIG. 6 is a drawing to show a screen display example of the browse client according to the embodiment of the invention;

FIG. 7 is a drawing to show a screen display example of the browse client according to the embodiment of the invention;

FIG. 8 is a drawing to show a screen display example of the browse client according to the embodiment of the invention;

FIG. 9 is a drawing to show a screen display example of a management client according to the embodiment of the invention;

FIGS. 10A to 10C are drawings to show screen display examples of the management client according to the embodiment of the invention;

FIGS. 11A and 11B are drawings to show screen display examples of the management client according to the embodiment of the invention;

FIG. 12 is a drawing to show a screen display example of the management client according to the embodiment of the invention;

FIG. 13 is a drawing to show a screen display example of the management client according to the embodiment of the invention;

FIGS. 14A and 14B are drawings to show screen display examples of the management client according to the embodiment of the invention; and

FIG. 15 is a drawing to show a screen display example of the management client according to the embodiment of the invention.

### DETAILED DESCRIPTION OF THE PREFERRED EMBODIMENTS

Referring now to the accompanying drawings, there is shown a preferred embodiment of the invention.

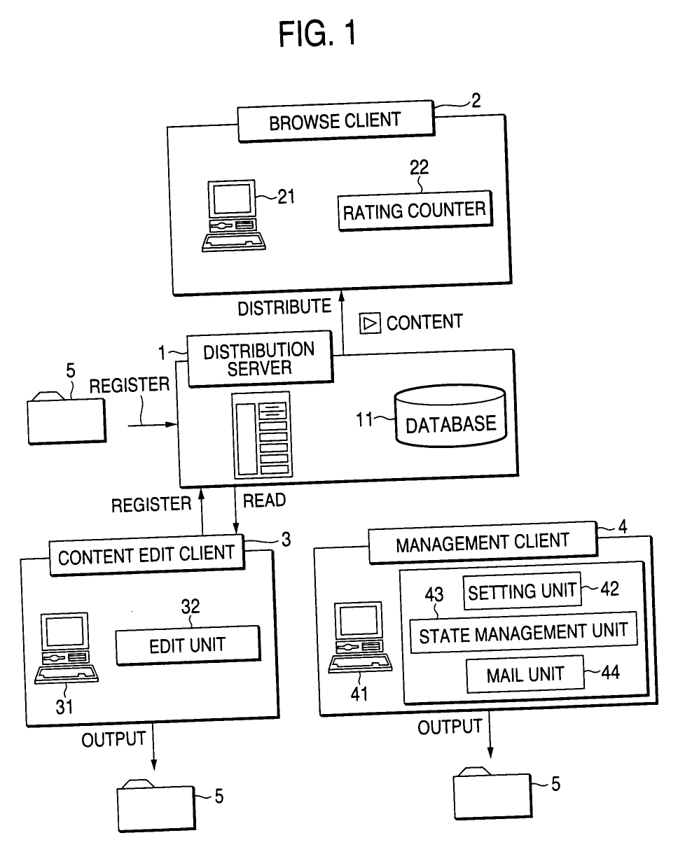

FIG. 1 shows a video browsing system according to the preferred embodiment of the invention. The video browsing system includes a distribution server 1, a browse client 2, an edit client 3, and a management client 4 connected through a computer network such as the Internet.

A plurality of browse clients 2, a plurality of edit clients 3, and a plurality of management clients 4 are provided as required.

Each of the distribution server 1, the browse client 2, the edit client 3, and the management client 4 is configured so that a program according to the invention is executed by computer hardware. The browse client 2, the edit client 3, and the management client 4 have displays 21, 31, and 41 each for displaying various pieces of information on a screen and are implemented each as a personal computer having a browser function to browse content and a mail transmission and reception function.

The browse client 2 has a viewing percentage counter 22 for counting the extent to which the user has browsed distributed video data on the browse client 2 (namely, the last position on the video data viewed by the user) as a viewing percentage (extent information) and retains the viewing percentage and also sends the viewing percentage to the distribution server 1.

The edit client 3 includes an edit unit 32. The edit unit 32 accesses the distribution server 1 and edits the content retained and managed by the distribution server 1. In the embodiment, content is registered in such a manner that video data and its slide data are collected in an archive file 5, and the content retained and managed by the distribution server 1 can be output from the edit client 3 or the management client 4 in such a manner that the content is collected in an archive file 5, enabling easy retention and management of the content and easy use of the content for other purposes.

The management client 4 includes a setting unit 42, a state management unit 43 and a mail unit 44. The setting unit 42 registers right of each user (participant) to browse various pieces of data and right of a content provider (lecturer) to edit, in the distribution server 1. The state management unit 43 manages information such as the session (session or course of the lecture) for each piece of content and the lecture attendance state of each user. The mail unit 44 prepares electronic mail (E-mail) and transmits the electronic mail to registered users.

In accordance with above units, the management client 4 performs processing of various processes such as registering users, granting the browse right for each piece of content to the users, granting the edit right for each piece of content to the registered user of a lecturer, acquiring the viewing percentage for each piece of content and for each user from the distribution server 1, displaying the viewing percentage on a screen for the manager, aiding the manager in preparing electronic mail, and transmitting prepared electronic mail to the users, as described later.

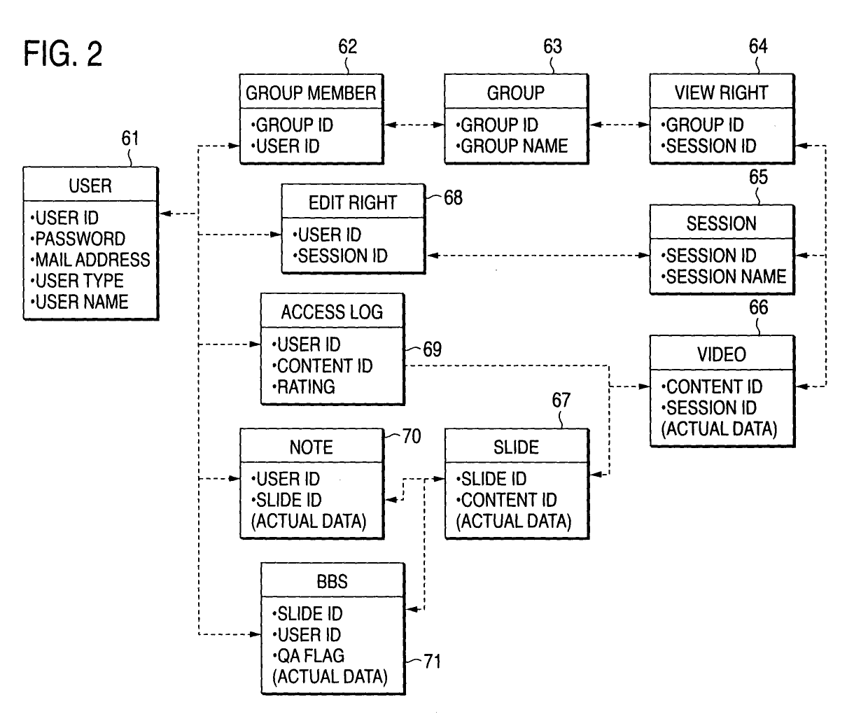

The distribution server 1 has a database 11 and retains and manages data as shown in FIG. 2 in the database 11, thereby providing a capability of distributing content including video data and slide data played back in synchronization with the video data and a capability of managing the browse right of each piece of content and the edit right of the piece of content. As the distribution server 1 is accessed from the browser client 2 of the user having the browse right, the distribution server 1 distributes the corresponding content to the user. As the distribution server 1 is accessed from the edit client 3 of the content provider having the edit right, the distribution server 1 allows the content provider to edit retained content.

FIG. 2 shows the data structures of the data retained and managed in the database 11 of the distribution server 1.

User data 61 contains user ID, password, E-mail address, user type, and user name for each of the users registered in the system. The user ID and the password are granted to the user by the management client (manager) 4 at the registering time. The E-mail address and the user name are set by the management client (manager) 4 based on user's application at the registration. The user type is the type of general user of browsing person, user of lecturer, or user of manager, and is set by the management client (manager) 4.

Group member data 62 related to the user ID of the user data 61 contains the group ID and the user ID. In the embodiment, the user IDs of a plurality of users are related to the same group ID, whereby the users are grouped for managing right grant (authorization). The group member data 62 is set by the management client (manager) 4, enabling the manager to easily form a class of a lecture like a group of the users participating in one lecture.

Group data 63 related to the group ID of the group member data 62 contains the group ID and the group name, and view right data 64 related to the group ID of the group data 63 contains the group ID and the ID of the session provided by content. The group data 63 and the view right data 64 are set by the management client (manager) 4, and the session whose view right (namely, browse right) is granted to the user group is set.

Session data 65 related to the session ID of the view right data 64 contains the session ID and the session name, and video data 66 related to the session ID of the session data 65 contains the content ID and the session ID. The session data 65 and the video data 66 are set by the management client (manager) 4, and the video data corresponding to the session is set.

Slide data 67 related to the content ID of the video data 66 contains the slide ID and the content ID and is set by the management client (manager) 4; the slide data corresponding to the video data is set.

The video data and the slide data (and the necessary metadata of the content name and the like) form a group of content to be distributed. The actual data of the video data and the slide data may be stored and managed in any other storage area of the database 11 or in any other database in association with each other with the content ID and the slide ID.

The actual data of the video data and the slide data can be edited by the edit client 3 of the user (lecturer) granted the edit right. When the lecturer performs operation of adding, changing, or deleting the video data or the slide data by the edit client 3 connected to the distribution server 1, the operation result is reflected on the database 11 by the edit unit 32.

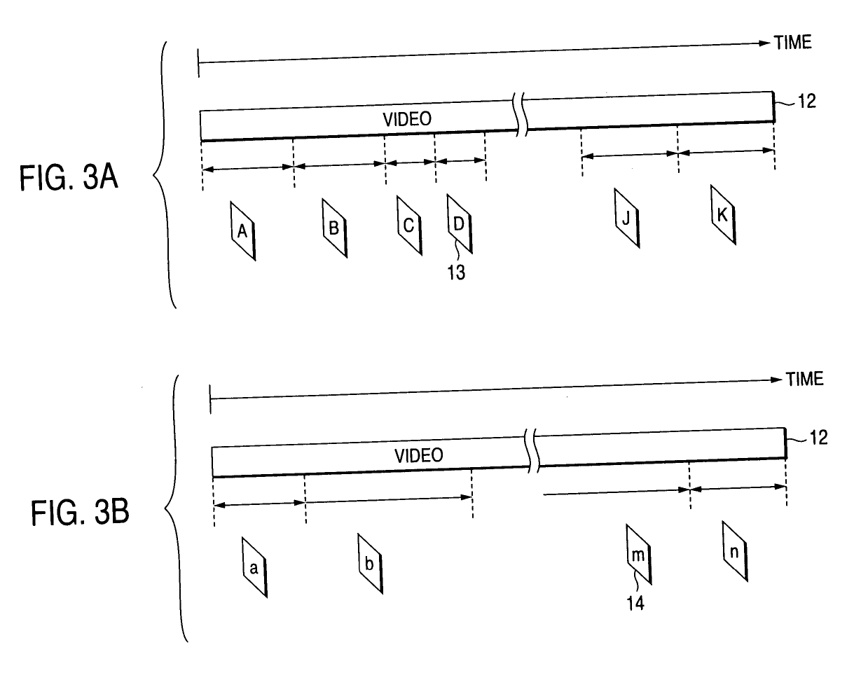

The video data and the slide data forming content are related to each other as shown in FIG. 3 and are synchronously played back on the browse client 1.

FIG. 3A shows the correspondence between video data (actual data) 12 and slide data 13, and FIG. 3B shows the correspondence between the video data 12 and representative frame data 14.

In the embodiment, a representative frame is also related to the video data in forming content so that it is played back in synchronization with the video data for use as a video data index. The representative frame is a still image representing a representative scene having one time width in video extracted from the video data 12, and is related to the corresponding scene of the video data 12.

The slide data 13 of a material image cited in a video lecture is a still image that the lecturer operating the edit client 3 relates to any desired playback time position of the video data 12. The lecturer relates as many pieces of the slide data 13 as required in response to the lecture contents to the necessary playback time positions of the video data 12.

Therefore, at the browse client 2 receiving distribution of content including the video data 12, the slide data 13, and the representative frame data 14, a video image is played back on the display 21 and in synchronization with this, a slide image and a representative frame image are also played back at predetermined positions, as described later.

As shown in FIG. 2, edit right data 68 related to the session ID of the session data 65 and the user ID of the user data 61 contains the user ID and the session ID and is set by the management client (manager) 4, and the user (lecturer) having the right of editing content is set for each session (content).

In the embodiment, processing of various configurations such as setting up a session, setting the users of the session, is performed as the management client 4 of the manager accesses the distribution server 1, and edit processing of the real image of content forming the session is performed as the edit client 3 of the lecturer accesses the distribution server 1.

Access log data 69 related to the user ID of the user data 61 and the content ID of the video data 66 contains viewing percentage data in addition to the user ID and the content ID. The user ID and the content ID are set by the management client (manager) 4, and as the viewing percentage data, the browse client 2 transmits the count of the viewing percentage counter 22.

The viewing percentage is data indicating the last point at which the browse user has displayed and browsed distributed video content on the screen of the browse client 2; the system keeps track of the extent to which each user browses the content at present based on the viewing percentage.

In the embodiment, whenever the distributed video content is displayed on the screen of the browse client 2, the viewing percentage counter 22 counts the playback start and end positions of the video, and the percentage of the time between the playback start and end positions to the total playback time of the video is calculated as the viewing percentage. In the embodiment, the viewing percentage counter 22 retains the counted video playback start and end positions and when the current playback end position is larger than the previously retained playback end position (later with respect to the time), the value is transmitted to the distribution server 1, which then updates the viewing percentage.

The viewing percentage may represent the extent to which the user has browsed relative to the whole content of the video and therefore the counting method and the calculating method of the viewing percentage are not limited to the embodiment and various methods can be adopted.

Note data 70 related to the user ID of the user data 61 and the slide ID of the slide data 67 contains text data entered as a note from the browse client 2 in addition to the user ID and the slide ID. The user ID and the slide ID are set by the management client (manager) 4, and the note text data is entered from the browse client 2 and is transmitted therefrom.

As described later, the browse user can operate the browse client 2 to take notes while displaying a slide image on the browse client 2, and the distribution server 1 retains and manages the notes taken by each user in association with the slide image.

BBS data 71 related to the user ID of the user data 61 and the slide ID of the slide data 67 contains text data entered as comments and questions from the browse client 2 in addition to the user ID and the slide ID. The user ID and the slide ID are set by the management client (manager) 4, and the BBS text data is entered from the browse client 2 and is transmitted therefrom.

As described later, the browse user can operate the browse client 2 to describe and enter BBS data in association with a slide image, and the distribution server 1 retains and manages the BBS description of each user in association with the slide image.

In the embodiment, the BBS data 71 contains a “Q flag” and a “A flag” (hereinafter, the both flags are generally referred to as “QA flag”). When a question is entered to the browse client 2 by the browse user, the distribution server 1 retains and manages the question with the Q flag on. When an answer to a question of another user is entered to the browse client 2 by the browse user, the distribution server 1 retains and manages the answer with the A flag on.

Therefore, a description couple of a question and its answer can be extracted from the BBS description using the QA flag.

Thus, the management client (manager) 4 accesses the distribution server 1 and sets various pieces of data in the database 11, whereby the user can access the distribution server 1 from the browse client 2 and can receive distribution of content data whose browse right is granted to the user. The distribution server 1 keeps track of the extent to which the user has viewed content browsed on the browse client 2, and the viewing percentage can be transmitted to the management client 4 for user management of the manager. The lecturer user can access the distribution server 1 from the edit client 3 and can edit the content data whose edit right is granted to the lecturer user.

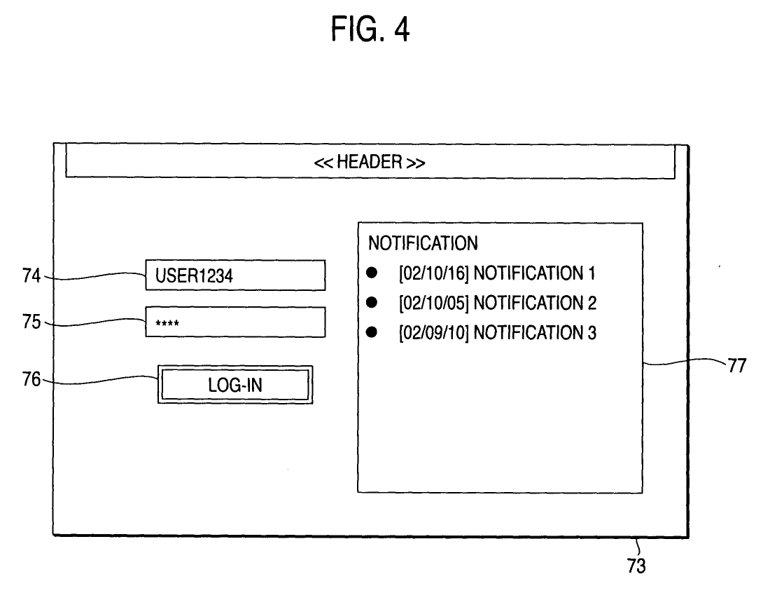

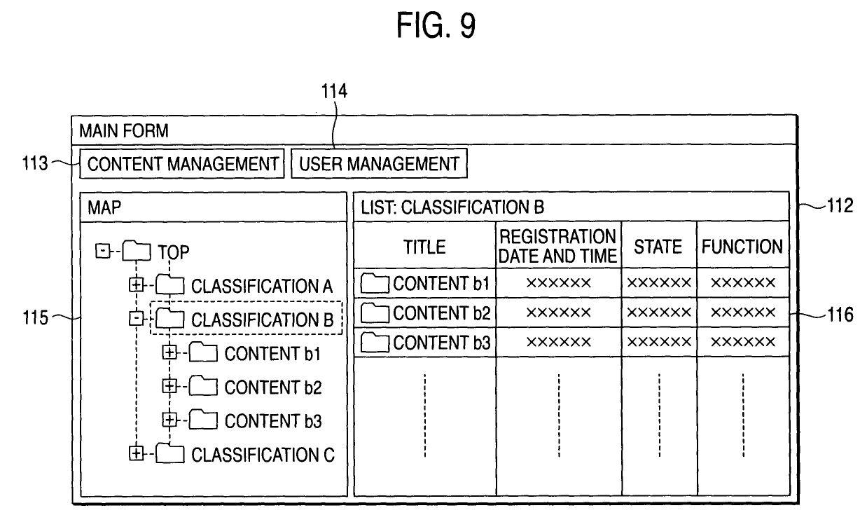

Next, the processing operation and functions of the system of the embodiment will be discussed with reference to examples of screen display of the browse client 2 shown in FIGS. 4-8 and examples of screen display of the management client 4 shown in FIGS. 9-14.

The edit client 3 does not have a permission to perform user registration, browse right setting, or edit right setting of the functions of the management client 4, but has equivalent functions to other functions of the management client 4 about content whose edit right is granted to the edit client 3 (namely, the session of which the lecturer takes charge).

When the user accesses the distribution server 1 from the browse client 2, a login page 73 as shown in FIG. 4 is displayed on the display screen 21 of the browse client 2. The login page 73 is provided with a user ID entry field 74, a user password entry field 75, a login button to input a login command, and a notification field 77 for displaying a notification registered by the manager in the database 11 of the distribution server 1 through the management client 4.

When the user enters the user ID and the password and clicks on the login button 76 (by clicking a button of a input device such as a mouse connected to the management client 4 with a mouse pointer pointed over the login button 76 on the screen), the user ID input in the user ID entry field 74 and the password input in the user password entry field 75 are transmitted to the distribution server 1, which then collates the user ID and the password with the user ID and the password set in the user data 61.

When user identification is authenticated as the result of the collating, the distribution server 1 references the view right data 64 and transmits content list data about all pieces of content whose browse right is granted to the user to the browse server 2.

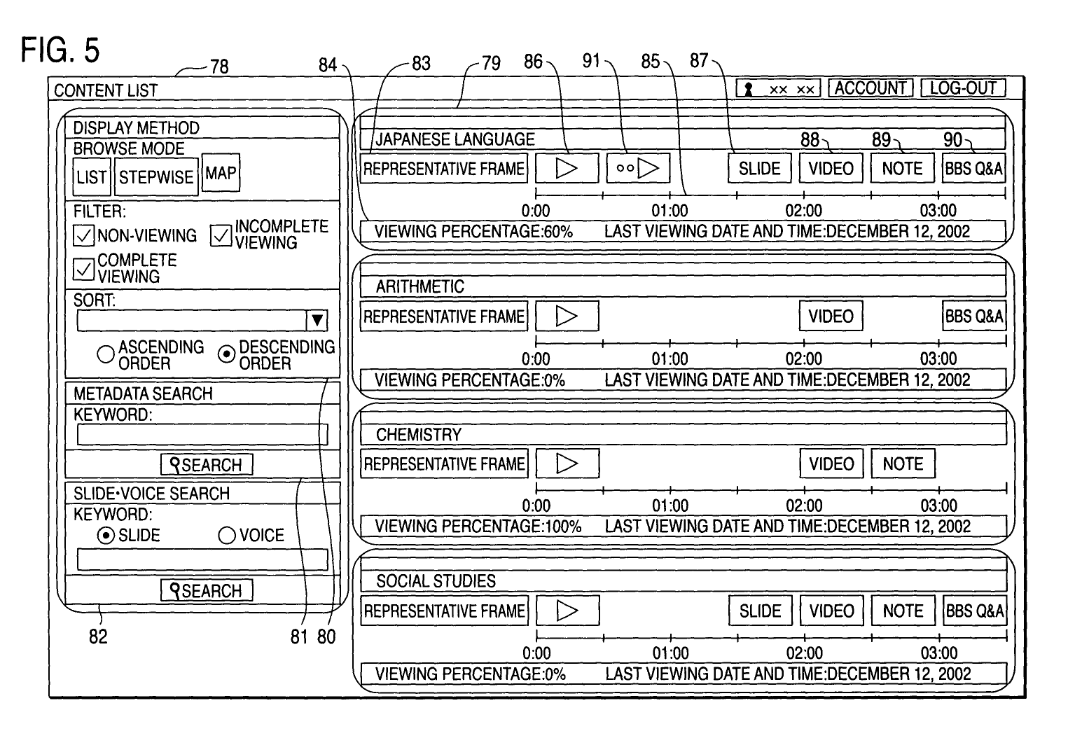

Accordingly, a content list page 78 as shown in FIG. 5 is displayed on the display screen 21 of the browse server 2.

The content list page 78 is provided with an operation area 79 for each piece of content, an operation area 80 to select a content list display method, and a metadata search operation area 81 and a slide voice search operation area 82 for searching for content.

The operation area 80 includes buttons for selecting a listing mode such as hierarchical type or map type, a filter condition setting part for selecting the pieces of content to be listed under conditions such as non-viewing, incomplete viewing and complete viewing, based on the viewing percentage for each piece of content, and a sort condition setting part for listing under a condition of ascending or descending order based on the last viewing date and time for each piece of content.

The metadata search operation area 81 includes a field for entering a keyword for making a search based on metadata such as the content title and the content producer, attached to each piece of content.

The slide voice search operation area 82 includes a field for entering a keyword for making a search based on text data related to slide data.

When content data is registered in the distribution server 1, the metadata and the voice search keyword are registered in association with each piece of content.

The operation area 79 for each piece of content includes an area 83 for displaying the content title set in the metadata and the representative frame related to the video data of the content, an area 84 for displaying the viewing percentage and the last viewing date and time of the video data, a gage 85 for indicating the playback time position of the video data, a playback start command button 86 of the video data, a slide listing command button 87 of the content, a display command button 88 of detailed information of the video data, a display command button 89 of notes taken in association with the slides of the content, and a button 90 for displaying and writing BBS described in association with the content and Q&A extracted from BBS.

The operation area 79 includes a button (midstream playback button) 91 for starting playback of video data at the time position of incomplete viewing except for content with viewing percentage of 0% or 100%. For example, when the user clicks the playback resume button 91 for content with viewing percentage 60%, the browse client 2 plays back the distributed video data starting at the time position with the passage of 60% from the top of the video data based on the playback end position retained in the viewing percentage counter 22.

Therefore, the user can click the playback resume button 91, thereby skipping the already viewed portion and playing back and browsing the video data from the beginning of the unviewed portion.

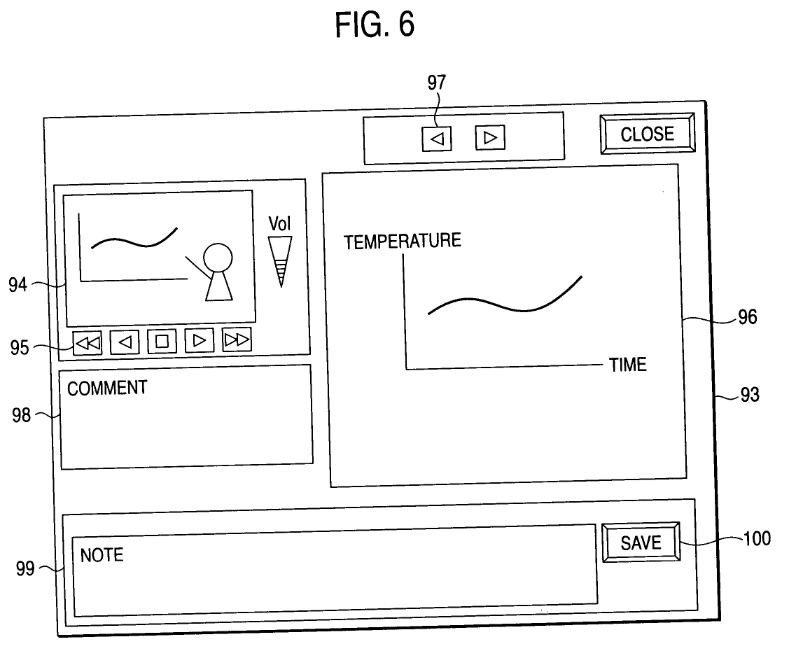

When the user clicks the playback start button 86 or the playback resume button 91, a request for distributing the content is transmitted to the distribution server 1, which then distributes the corresponding content to the browse client 2 and a content browse page 93 as shown in FIG. 6 is displayed on the display screen 21.

The content browse page 93 includes an area for playing back and displaying content video data, buttons 95 for entering commands of video playback start, stop, etc., an area 96 for playing back and displaying content slide data in synchronization with the video, buttons 97 for entering commands of advancing and returning a slide image, an area 98 for displaying a comment attached by the lecturer to the video data, an area 99 for the browse user to write a note by operating the browse client 2, and a save button 100 for transmitting the written note to the distribution server 1 for retaining the note in the database 11.

Since the video data and the slide data are related to each other as shown in FIG. 3, the slide image displayed in synchronization with playing back the video data is changed in order. When the user clicks the button 97 for changing the displayed slide image, the playback time position of the displayed video data is also changed to the position corresponding to a new slide image.

Since the slide images and the notes are related to each other as shown in FIG. 2, when the displayed slide image is changed, the note description in the area 99 is also changed. Therefore, the user can take a note in association with the slide image and from the slide image or note description, the corresponding note description or slide image can be displayed on the screen.

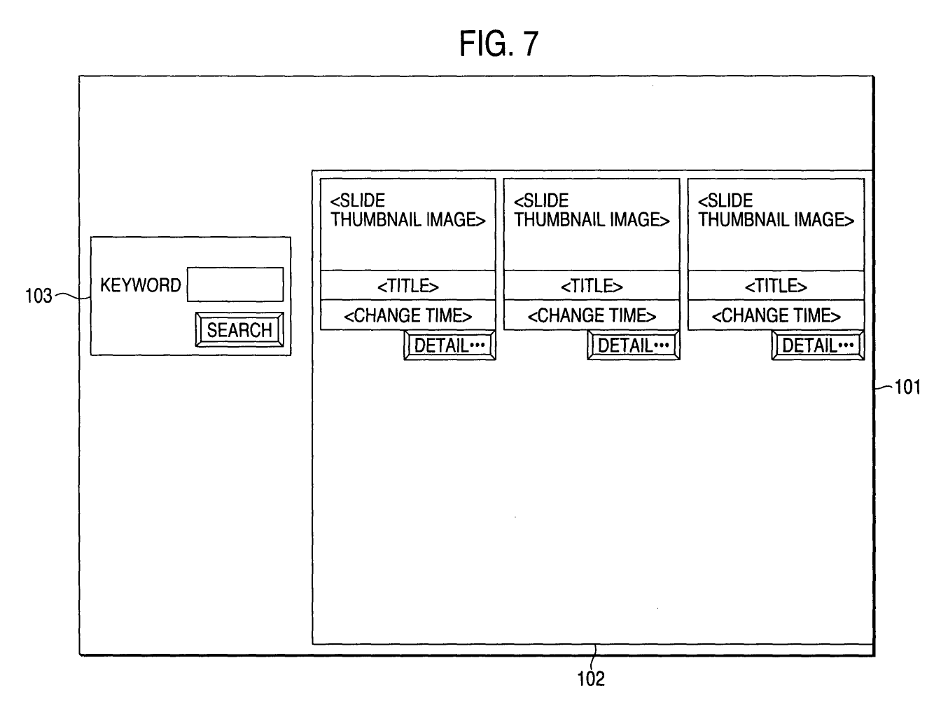

When the user clicks the slide button 87, a request for slide distribution of the content is transmitted to the distribution server 1, which then distributes a slide data list of the corresponding content to the browse client 2 and a slide list page 101 as shown in FIG. 7 is displayed on the display screen 21.

The slide list page 101 includes an area 102 for displaying all slide images included in the content as thumbnail images and an area 103 for entering a keyword for making a search based on metadata of the title, etc., attached to each slide image, so that the user can easily find out any desired slide image and further can click the found slide image, thereby playing back and displaying the video data starting at the corresponding time position.

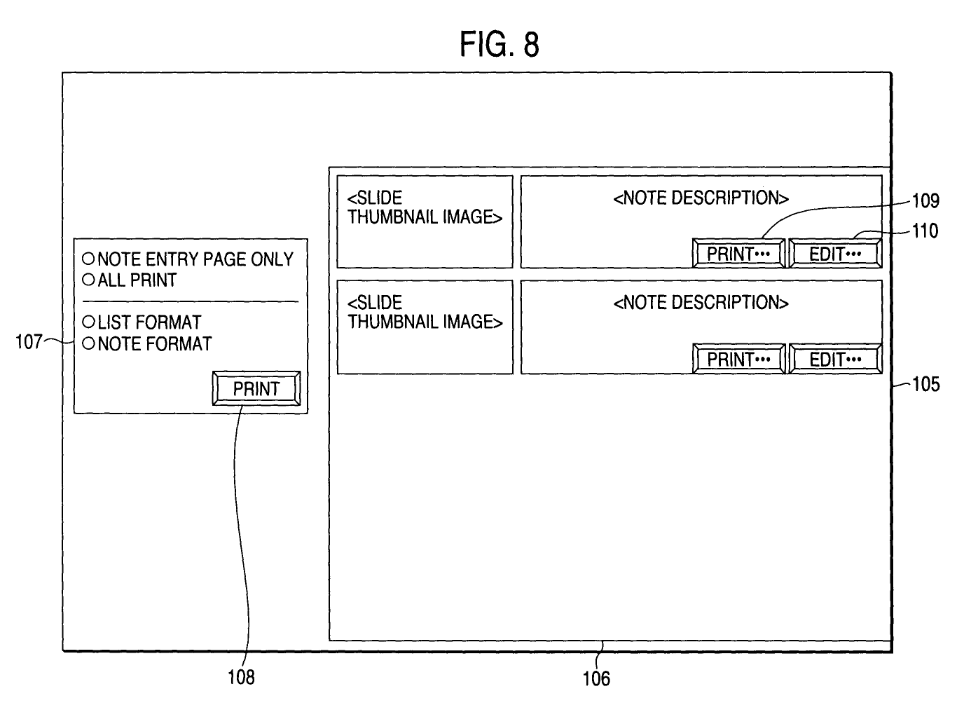

When the user clicks the note button 89, a request for note distribution of the content is transmitted to the distribution server 1, which then distributes a note list of the corresponding content to the browse client 2 and a note list page 105 as shown in FIG. 8 is displayed on the display screen 21.

The note list page 105 includes an area 106 for displaying the note description together with the slide image thumbnail and an area 107 containing a button 108 for printing the list with the print format specified, so that the user can display on the screen or print out his or her taken note corresponding to the slide image.

A print button 109 and an edit button 110 are provided for each note displayed on the note list page 105. The user can click the print button 109, thereby printing out only the corresponding note description and can click the edit button 110, there by editing the note description. The note description edit result is transmitted to the distribution server 1 and is reflected on the corresponding note description retained in the distribution server 1.

When the manager accesses the distribution server 1 from the management client 4, a login page similar to that shown in FIG. 4 is displayed on the display screen 41 of the management client 4. When the user enters the user ID and the password and clicks a login button, the user ID and the password are transmitted to the distribution server 1, which then collates the user ID and the password with the user ID and the password set in the user data 61. Although not shown in FIG. 2, the user ID and the password of the user having the manager right are registered in the database 11.

When manager identification is authenticated as the result of the collating, the distribution server 1 transmits the data retained in the database 11 to the management client 4 in response to the access from the management client 4, and updates the corresponding data in the database 11 to the data transmitted from the management client 4.

As the manager thus logs in, a main form page 112 provided with a content management button 113 and a user management button 114 as shown in FIG. 9 is displayed on the display screen 41 of the management client 4.

FIG. 9 shows a state in which the manager clicks the content management button 113 on the main form page 112. As the manager clicks the content management button 113, the state management unit 43 is started. All content files registered in the database 11 of the distribution server 1 are displayed in a map display area 115 in a map format. All content files (in FIG. 9, only the content files having titles content b1, content b2 and content b3 is shown) included in the content file clicked to in the map display area 115 (in the example shown in the figure, content file having title of classification B) are listed in a listing area 116.

Registration date and time information, state information indicating whether or not the content can be browsed by the user, and function information indicating whether or not the functions such of notes and BBS, are provided for the content are also displayed in the listing area 116 together with the content titles, so that the manager can keep track of the current state of each piece of content.

Similar information can also be displayed on the screen through the edit client 3, and the lecturer can check the current state of the content of which the lecturer takes charge.

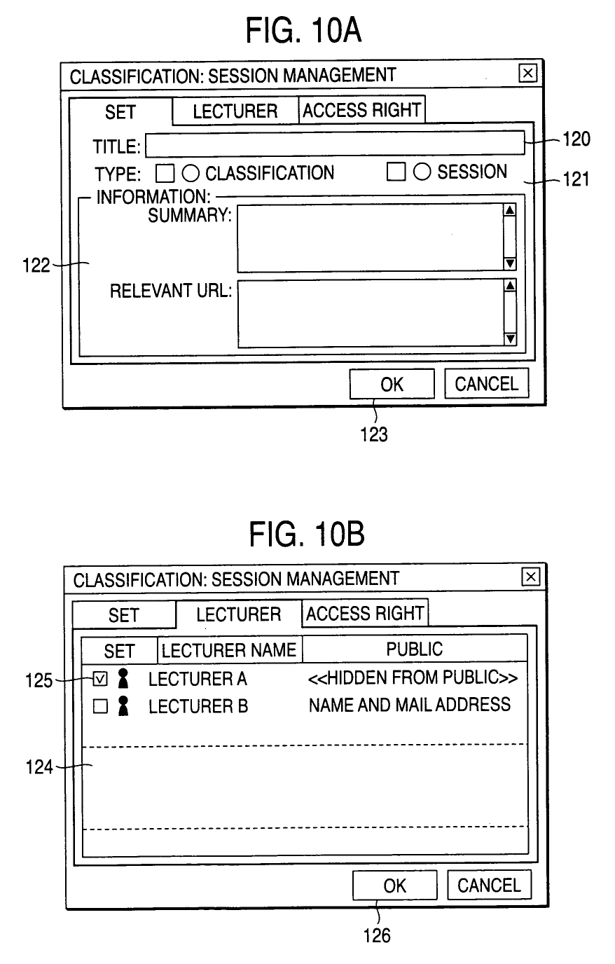

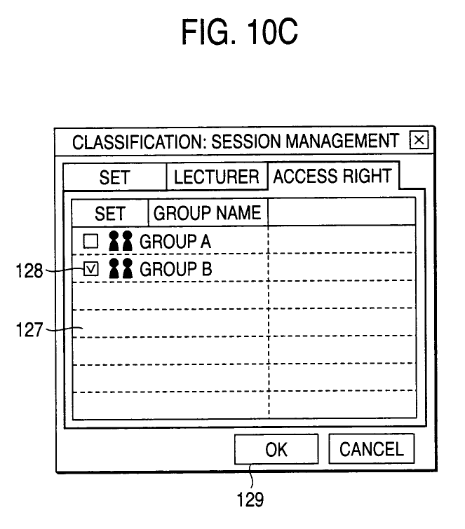

Node management dialog windows shown in FIGS. 10A to 10C are displayed on the screen 41 together with the screen display shown in FIG. 9. Using the dialog windows, the manager can conduct setting for each node (classification unit shown in FIG. 9) for the database 11 of the distribution server 1.

The dialog window shown in FIG. 10A is provided for setting a node (classification) and includes a node title entry field 120, an operation area 121 for specifying the node type of classification or session content included therein as shown in FIG. 9, and an entry field 122 of a summary concerning the node and relevant URL.

The manager makes required entries in the node management dialog window (setting) and clicks an OK button 123, whereby the setting unit 42 can be started and the setup contents can be transmitted to the distribution server 1 for setting a new node in the session data 65 of the database 11.

The dialog window shown in FIG. 10B is provided for setting a lecturer for the node and includes a listing field 124 of lecturer candidates.

Check boxes 125 are provided in a one-to-one correspondence with the candidates. The manager clicks the check box 125 of the candidate to be set to the lecturer in the node and clicks an OK button 126, whereby the setting unit 42 can be started and the setup contents can be transmitted to the distribution server 1 for setting the candidate in the edit right data 68 of the database 11 as the lecturer.

The dialog window shown in FIG. 10C is provided for setting browse users for the node and includes a listing field 127 of groups of browse users as candidates. In the example, a plurality of browse users are previously grouped and the browse right for the node is set in user group units, but the browse right may be set for each user without such grouping.

Check boxes 128 are provided in a one-to-one correspondence with the candidates. The manager clicks the check box 128 of the candidate to be granted the node browse right and clicks an OK button 129, whereby the setting unit 42 can be started and the setup contents can be transmitted to the distribution server 1 for setting the candidate (group) in the viewing right data 64 of the database 11 as the browse user group.

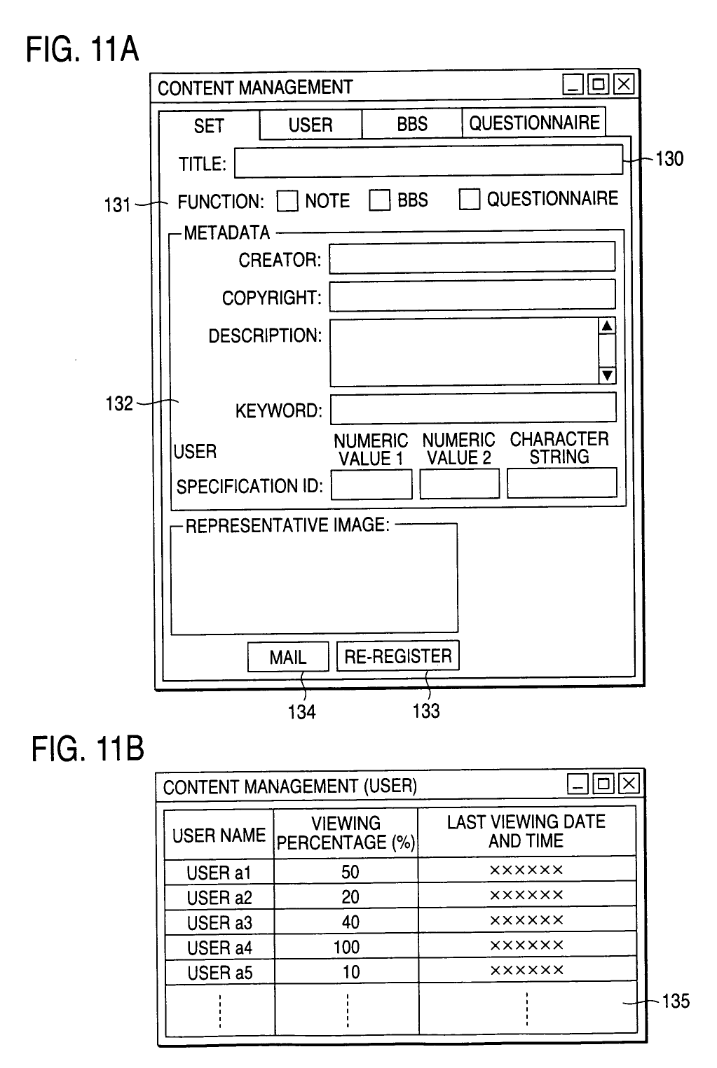

Content management dialog windows shown in FIGS. 11A and 11B are displayed on the display screen 41. Using the dialog windows, the manager can conduct setting for each node (content unit shown in FIG. 9) for the database 11 of the distribution server 1, and data can be acquired from the distribution server 1 for display on the screen.

The dialog window shown in FIG. 11A is provided for setting content and includes a content title entry field 130, an operation area 131 for specifying whether or not the function such of note, BBS and questionnaire is provided for the content, and a metadata entry field 132 of information concerning the content, the information such of the creator.

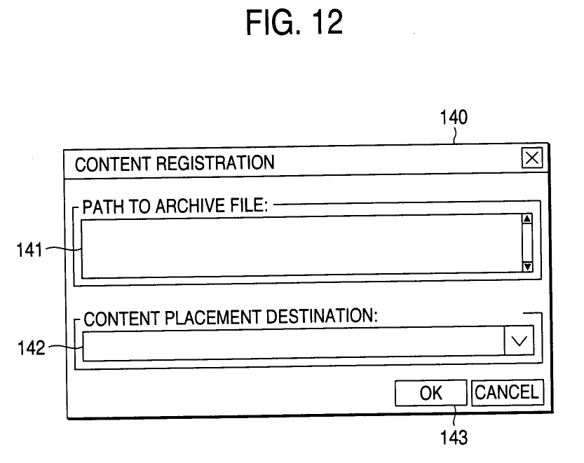

The manager makes required entries in the content management dialog window and clicks a register button 133, whereby the setting unit 42 can be started, a content registration dialog window 140 shown in FIG. 12 is displayed on the screen 41, and the setup contents can be transmitted to the distribution server 1 for registering new content in the database 11 or updating content.

A mail button 134 is used to start the mail unit 44 as described later.

A similar function can also be executed by the edit unit 32 of the edit client 3 and the lecturer can also add, delete, or change content included in classification.

The dialog window shown in FIG. 11B is provided for displaying the user viewing percentage state of one content and includes a listing field 135 of the state concerning each of the users in the user group granted the browse right of the content.

Using the state management unit 43 of the management client 4, the user data 61 and the access log data 69 are acquired from the distribution server 1 and the viewing percentages and the last viewing dates and times are displayed in the listing field 135 together with the user names, so that the manager can keep track of the extent to which each user has browsed the content and the last time when each user browsed the content.

The content registration dialog window 140 shown in FIG. 12 is provided for registering the content file collected as the archive file 5 as the video data 66 and the slide data 67 in the database 11 and includes a field 141 for entering an archive file path and a field 142 for entering the content placement destination.

The manager (lecturer) makes required entries in the content management dialog window and clicks a register button 143, whereby the setting unit 42 can be started and the setup contents and the archive file can be transmitted to the distribution server 1 for registering new content in the database 11 or updating content. Content can be deleted by deleting the file path and outputting as the archive file 5.

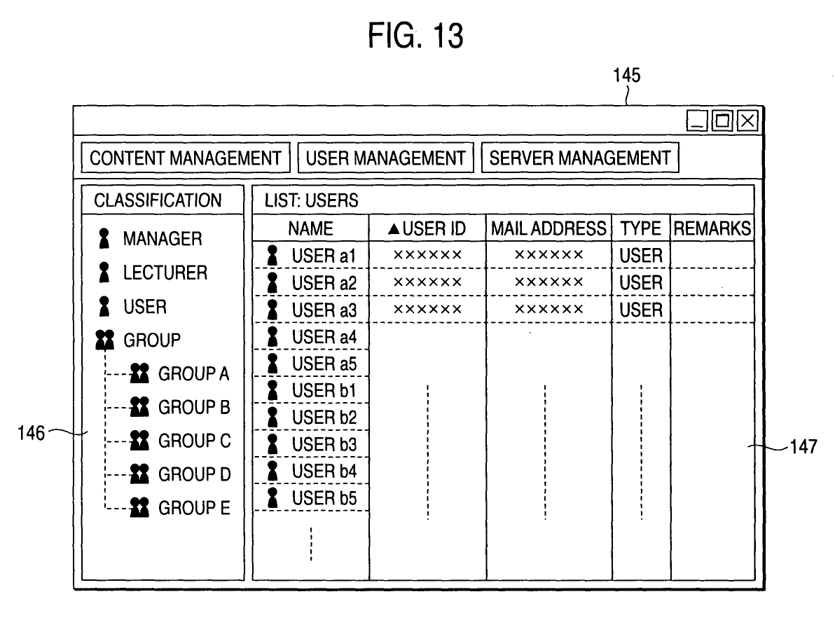

The manager clicks a user management tab on the main form page 112 shown in FIG. 9, whereby a user management page 145 shown in FIG. 13 is displayed on the screen 41 and the manager can use the user management page 145 to set the registered users as candidates for the manager and the lecturer and group the registered users.

The user management page 145 includes a display field 146 of the manager, the lecturer, and the user groups and a listing field 147 of all registered users. Using the state management unit 43 of the management client 4, the data is acquired from the distribution server 1, all registered user group names are displayed in the user group field 146, and the user names, user IDs, E-mail addresses, and types of all users are displayed in the listing field 147.

When the manager specifies any user displayed in the listing field 147 as any of the manager, lecturer, or user group displayed in the group field 146 by performing clicking operation, the specified user can be set to a manager candidate, a lecturer candidate, or a user group member.

Therefore, using the setting unit 42 of the management client 4, the manager can set any user to a manager candidate, a lecturer candidate, or a member of any desired user group, and can grant the edit right and the browse right for each piece of content.

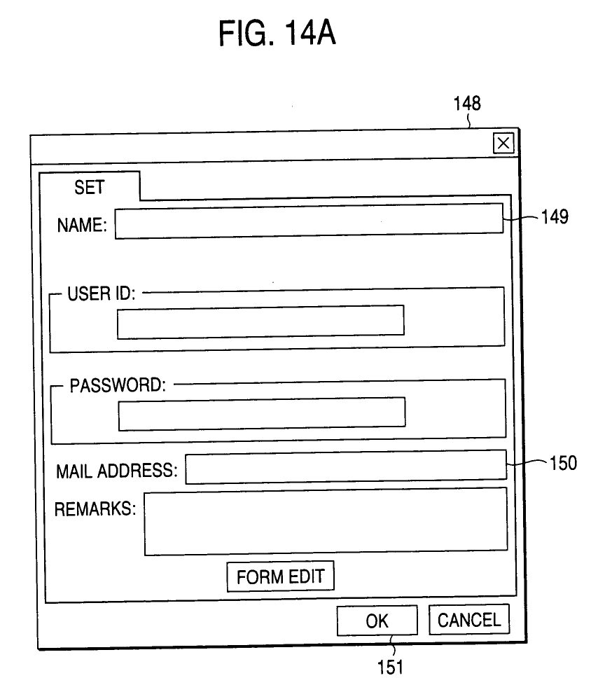

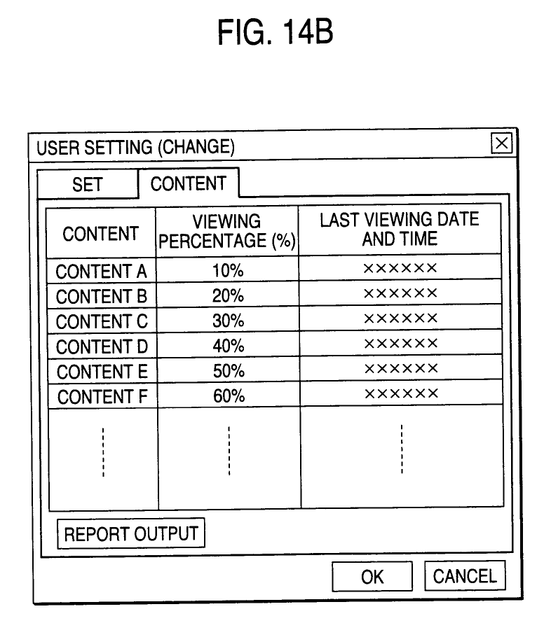

A new user can be registered in the system as a user setting dialog window 148 shown in FIG. 14 is displayed on the screen 41. The user setting dialog window 148 includes a user name entry field 149 and a E-mail address entry field 150, enabling the manager to register user data in the system.

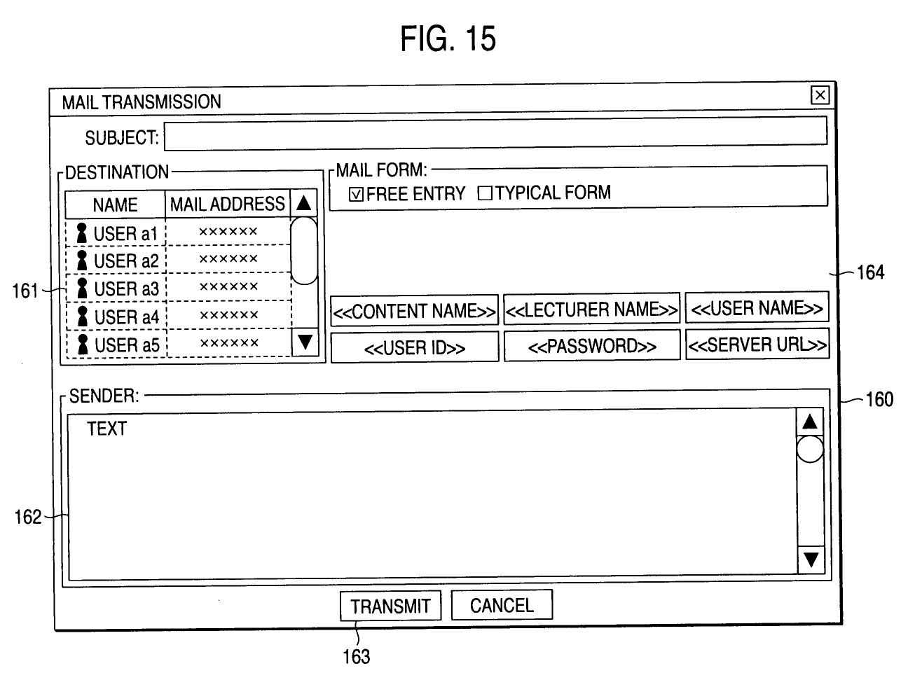

The manager makes required entries in the user setting dialog window and clicks an OK button 151, whereby the setting unit 42 can be started and the setup contents can be transmitted to the distribution server 1 for registering a new user in the user data 61 in the database 11. The user ID and the password of the user are generated automatically by the setting unit 42, are transmitted to the distribution server 1, and are registered in the user data 61 in the database 11. Using the mail unit 44 shown in FIG. 15, etc., the user ID and the password are sent from the manager to the corresponding user by electronic mail.

The manager clicks the mail button 134 in the content management dialog window shown in FIG. 11A, whereby the mail unit 44 is started and a mail transmission dialog window 160 shown in FIG. 15 is displayed on the screen 41. The edit client 3 also has a similar function for content whose edit right is granted.

The mail transmission dialog window 160 includes destination information display field 161 and a mail text entry field 162. The names and E-mail addresses of the users granted the browse right of the content are automatically listed in the destination information field 161.

Therefore, as the manager enters mail text in the entry field 162 through a keyboard of the management client 4 and clicks a transmit button 163, the manager can transmit electronic mail to all users displayed in the destination information field 161 and can easily provide the users for each piece of content with information about the content.

Here, the mail unit 44 can aid the user in mail preparation, and the manager can click built-in buttons 164, thereby automatically building information such of the content name and the lecturer name of the content, in the entry field 162.

Further, the mail unit 44 can aid the manager in selecting destinations, and any desired user information can be deleted from the destination information field 161 for excluding the corresponding user from the mail destinations. The mail unit 44 can also aid the manager in selecting destinations for sorting the users displayed in the destination information field 161 in the ascending order or the descending order based on the viewing percentage and further transmitting electronic mail only to the users with one viewing percentage or more (or less)

Therefore, mail for prompting the user to view content can be easily transmitted to the user with a low viewing percentage, for example, and the user can be prompted to browse content under management.

In the embodiment above described, the management of the extent information (including editing the extent information) is provided by separate clients of the edit client 3 and the management client 4. However, the management of the extent information may be provided by a single client.

In the embodiment above described, the distribution of the content and the management of the extent information is provided by separate clients and server. However, the distribution of the content and the management of the extent information may be provided by a single computer (e.g. the distribution server 1).

As described above, according to the invention, the system keeps track of the extent to which each user has browsed distributed video data and thus can keep track of the user's needs for the video data and the user's learning progress using the video data; system administration adapted for the purpose can be realized.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A video browsing system comprising:
a distribution server configured to distribute content including video data; and
a browse client configured to receive the distributed content and to play back the video data included in the content onto a display screen thereof,
wherein the distribution server comprises a manage unit configured to manage an extent information that indicates an extent of browsing the content for each user receiving distribution of the content through the browse client.

2. The video browsing system as claimed in claim 1, further comprises a management client,
wherein the management client comprises: a register unit configured to register a user for browsing the content with the browse client; and a E-mail unit configured to create and send an E-mail to each user, and
wherein the distribution server comprises a transmit unit configured to transmit the extent information to the management client for providing management information.

3. A video browsing system comprising:
a distribution server configured to distribute content including video data; and
a browse client configured to receive the distributed content and to play back the video data included in the content onto a display screen thereof,
wherein the browse client comprises: a counting unit configured to count an extent to which a user has played back the video data and to update extent information indicating the extent counted; and a transmitting unit configured to transmit the extent information to the distribution server, and
wherein the distribution server comprises a manage unit configured to manage the extent information transmitted from the browse client in association with the content and the user.

4. The video browsing system as claimed in claim 3, wherein the browse client comprises a display control unit configured to determine whether the content is incompletely browsed by the user or not based on the extent information, and to display onto the display screen a midstream playback button for playing back the video data starting at the previous stop position for the content in a case where the content is incompletely browsed by the user.

5. The video browsing system as claimed in claim 3, further comprises a management client,
wherein the management client comprises: a register unit configured to register a user for browsing the content with the browse client; and a E-mail unit configured to create and send an E-mail to each user, and
wherein the distribution server comprises a transmit unit configured to transmit the extent information to the management client for providing management information.

6. A browse client comprising:
a receiving unit configured to receive a content including video data distributed from a distribution server;
a display screen configured to display and play back the video data included in the content;
a counting unit configured to count an extent to which a user has played back the video data and to update extent information indicating the extent counted; and
a transmitting unit configured to transmit the extent information to the distribution server.

7. A browse client comprising:
a receiving unit configured to receive a content including video data distributed from a distribution server;
a display screen configured to display and play back the video data included in the content;
a counting unit configured to count an extent to which a user has played back the video data and to update extent information indicating the extent counted; and
a display control unit configured to determine whether the content is incompletely browsed by the user or not based on the extent information, and to display onto the display screen a midstream playback button for playing back the video data starting at the previous stop position for the content in a case where the content is incompletely browsed by the user.

8. A distribution server comprising:
a distribution unit configured to distribute content including video data to a browse client;
a receiving unit configured to receive extent information that indicates an extent of browsing the content for each user receiving distribution of the content through the browse client, from the browse client; and
a manage unit configured to manage the extent information transmitted from the browse client in association with the content and the user.

9. A computer program product for controlling a browse client, the program product comprising:
means for receiving a content including video data distributed from a distribution server;
means for displaying and playing back the video data included in the content onto a display screen of the browse client;
means for counting an extent to which a user has played back the video data and updating extent information indicating the extent counted; and
means for transmitting the extent information to the distribution server.

10. A computer program product for controlling a browse client, the program product comprising:
means for receiving a content including video data distributed from a distribution server;
means for displaying and playing back the video data included in the content onto a display screen of the browse client;
means for counting an extent to which a user has played back the video data and updating extent information indicating the extent counted;
means for determining whether the content is incompletely browsed by the user or not based on the extent information; and
means for displaying onto the display screen a midstream playback button for playing back the video data starting at the previous stop position for the content in a case where the content is incompletely browsed by the user.

11. A computer program product for controlling a distribution server, the program product comprising:
means for distributing content including video data to a browse client;
means for receiving from the browse client extent information indicating an extent to which a user has played back the video data; and
means for managing the extent information transmitted from the browse client in association with the content and the user.

12. A video browsing method comprising:
distributing content including video data from a distributing server to a browse client;
receiving the content distributed from the distributing server by the browse client;
displaying and playing back the video data included in the received content onto a display screen of the browse client;
counting an extent to which a user has played back the video data, by the browse client;
updating extent information indicating the extent counted, by the browse client;
transmitting the extent information from the browse client to the distribution server; and
managing the extent information transmitted from the browse client in association with the content and the user, by the distribution server.

13. A video browsing method comprising:
receiving content including video data distributed from a distributing server;
displaying and playing back the video data included in the received content onto a display screen;
counting an extent to which a user has played back the video data;
updating extent information indicating the extent counted; and
determining whether the content is incompletely browsed or not based on the extent information; and
displaying onto the display screen a midstream playback button for playing back the video data starting at the previous stop position for the content in a case where the content is incompletely browsed by the user.
